(19) United States
(12) Patent Application Publication
(10) Pub. No.: US 2015/0026051 A1
(43) Pub. Date: Jan. 22, 2015

(54) SYSTEM, METHOD AND ARTICLE OF MANUFACTURE FOR FACILITATING INSTANTANEOUS CASH DEPOSIT

(71) Applicant: Tata Consultancy Services Limited, Maharashtra (IN)

(72) Inventors: Sachin Kumar Agrawal, Bangalore (IN); Sneha Bose, Bangalore (IN); Shalin Garg, Bangalore (IN); Sathish Vallat, Bangalore (IN)

(21) Appl. No.: 14/333,640

(22) Filed: Jul. 17, 2014

(30) Foreign Application Priority Data
Jul. 17, 2013 (IN) 2386/MUM/2013

(51) Int. Cl. G06Q 20/10; G06Q 20/40; G06Q 20/30

(52) U.S. Cl. CPC G06Q 20/1085; G06Q 20/30; G06Q 20/40145
USPC 705/41; 705/42

(57) ABSTRACT

The present disclosure relates to a financial instrument having a monetary value associated with it and a system and method for using such financial instrument. The financial instrument is generated by a bank and further issued to a retailer for further distribution. The customer who wishes to deposit a cash amount into a specific bank account in the offline environment may buy such financial instrument from the retailer's location. At the time of buying, the financial instrument is activated by the bank's server (system) upon authentication of retailer's and customer's identity. After activation, the retailer/customer may initiate the deposition of the cash amount by redeeming the financial instrument. The redemption may be carried out by various authentication techniques. Once the retailer and the customer are successfully authenticated, the cash amount is instantly deposited into the given bank account. The deposited cash amount is equivalent to the financial instrument purchased by the customer.

### CROSS-REFERENCE TO RELATED APPLICATIONS AND PRIORITY

The present application claims priority to Indian Provisional Patent Application No. 2386/MUM/2013, filed on Jul. 17, 2013, the entirety of which is hereby incorporated by reference.

### TECHNICAL FIELD

The present disclosure relates to a financial instrument (i.e., physical deposit voucher) for performing a financial transaction. More particularly, the present disclosure relates to a method and a system for a real-time deposition of a cash amount in an offline environment.

### BACKGROUND

Unlike withdrawing a cash amount instantly from a bank's Automatic Teller Machines (ATMs) or from any other withdrawing stations, depositing the cash amount and thereby reflecting the cash deposited into one's account instantaneously in an offline environment may not be possible in the banking systems available today. When a bank customer wants to deposit the cash amount into his/her bank's account or any other bank's account, he/she has to initiate the request for depositing the cash during working hours of the concerned banks or cash depositing units. After the working hours or during non-working days, the banks may not process any request received from the customer for depositing the cash. Further, such offline process requires the customer to physically visit the concerned bank's ATM or the depositing units for depositing the cash amount. Further, in certain scenarios, even when the request for depositing the cash is accepted and initiated by the bank, it may further take at least one working day for facilitating the cash amount to be deposited and thereby reflect into the customer's account.

Thus, the available solutions or approaches followed for depositing the cash amount in the offline mode is onerous and a time consuming process. Also, in cases where ATMs are being used for cash deposit, there is no cross-check or validation-check of the cash amount being deposited at the ATM in an envelope and the amount keyed/entered on the screen of the ATM by the person depositing the cash. Hence, there may be a possibility of a variation between the amount entered on the screen and the actual cash amount kept into the envelope by the person. Thereafter, the deposited cash amount in the envelope may reach to the concerned bank at the teller's desk or any other person responsible for counting and validating the cash amount deposited. Thus, the conventional process involves an additional stage in the form of teller processing during the cash deposit which further increases the processing time and delay in the cash being deposited in the customer's account.

Thus, in view of the above, there is a long-felt need in the art for a method and system that facilitates an instantaneous cash deposit in an offline banking environment.

### SUMMARY

This summary is provided to introduce aspects related to an article of manufacture, systems and methods for facilitating financial transactions are described below in the detailed description. This summary is not intended to identify essential features of disclosure nor is it intended for use in determining or limiting the scope of the subject matter.

In one implementation, a system for facilitating a financial transaction using a financial instrument is disclosed. The system comprises a processor and a memory coupled to the processor for executing a plurality of modules stored in the memory. The plurality of modules comprises an activation module and a deposition module. The activation module receives an activation request, from a communication device, for activating a financial instrument having a monetary value associated therewith. The activation request comprises metadata associated with the activation request, whereby the metadata comprises a bank account of a user associated with the communication device. The activation module further validates the activation request for activating the financial instrument based upon the metadata. Further, the deposition module receives, after the activation of the financial instrument, a deposition request, from the communication device. Further, the deposition request comprises the monetary value associated with the financial instrument. The deposition module further processes the deposition request in order to deposit the monetary value into the bank account of the user associated with the communication device, whereby the bank account is being determined using the metadata.

In another implementation, a method for facilitating a financial transaction is disclosed. The method may include receiving by a processor, an activation request, from a communication device, for activating a financial instrument having a monetary value associated therewith. The activation request comprises metadata associated with the activation request, whereby the metadata comprises the bank account of a user associated with the communication device. The method may further include validating by the processor, the activation request for activating the financial instrument based upon the metadata. Further, the method may include receiving by the processor, after the activation of the financial instrument, a deposition request, from the communication device. Further, the deposition request comprises the monetary value associated with the financial instrument. The method may further include processing by the processor, the deposition request in order to deposit the monetary value into the bank account of the user associated with the communication device, whereby the bank account is being determined using the metadata.

Yet in another implementation a non-transitory computer readable medium embodying a program executable in a computing device for facilitating a financial transaction is disclosed. The program may include a program code for receiving an activation request, from a communication device, for activating a financial instrument having a monetary value associated therewith. Further, the activation request comprises metadata associated with the activation request, and the metadata comprises the bank account of a user associated with the communication device. The program may further include a program code for validating the activation request for activating the financial instrument based upon the metadata. Further, the program may include a program code for receiving, after the activation of the financial instrument, a deposition request, from the communication device, whereby the deposition request comprises the monetary value associated with the financial instrument. The program may further include a program code for processing the deposition request in order to deposit the monetary value into the bank account of the user associated with the communication device, whereby the bank account is being determined using the metadata.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates the financial instrument 100, in accordance with an embodiment of the present subject matter.

FIG. 2 illustrates a system, in accordance with an embodiment of the present subject matter.

FIG. 3 illustrates a network implementation of the system and its detail working for facilitating a cash deposition instantly using the financial instrument, in accordance with an embodiment of the present subject matter.

FIG. 4 illustrates a method for facilitating the financial transaction, in accordance with an embodiment of the present subject matter.

### DETAILED DESCRIPTION

A financial instrument, systems, and methods for facilitating a financial transaction are described. The present disclosure relates to an instantaneous deposition of cash amount into a specified bank's account in real-time. The present disclosure may allow a user to instantly deposit the cash amount into the specified bank's account by using the financial instrument or a deposit voucher. Further, the cash amount deposited may be reflected into the bank's account in real-time, thus giving confirmation to the user regarding the successful deposition of the cash amount. The financial instrument or the deposit voucher may be issued by a bank or a financial institution to a retailer or any other bank's certified service providers. In one embodiment, the financial instrument may also be issued to a customer by the financial institution or the retailer. Further, the term “retailer” and “customer” may be collectively referred as “user”. For issuing the financial instrument/deposit voucher, the bank or the financial institution may use a voucher printing device for printing the financial instrument/deposit voucher in a physical form and thereafter issuing it to the user (i.e., the retailer or the customer). According to an embodiment, the retailer may act like a distributing as well as depositing unit for the customers who want to use such financial instrument/deposit voucher for depositing the cash amount into the specified bank's account.

In an aspect of the present disclosure, the customer may visit the retailer for buying the deposit voucher by paying the cash amount which is equivalent to the deposit voucher. The financial instrument/deposit voucher may come along with different monetary values which may be further bought by the customers according to their financial requirement. Here, the retailer acts like the distribution unit or selling unit of the financial instrument/deposit voucher issued by the bank/financial institution for the customer. At the retailers' location i.e., the distribution unit, a retailer device may be used for communicating with the bank's server (system) to activate the financial instrument/deposit voucher which is to be sold to the customer. According to an embodiment, the customer having a customer device may also be used for communicating with bank's server (system) to activate the financial instrument/deposit voucher. The “retailer device” and the “customer device” may be collectively referred as “communication device”. Further, the financial instrument/deposit voucher may get activated by bank's server (system) in the name of the customer after receiving and validating a metadata associated with the user (the retailer and the customer). The metadata may further comprise information related to the retailer and the customer, whereby the metadata may comprise a customer's bank details, customer's authentication code, retailer's authentication code, customer's personal details or any other details for example biometric data which may be required by the bank's server (system) for validating the customer's identity and retailer's identity. An application program may be installed on the communication device (i.e., the retailer device or the customer device) for facilitating the verification, activation and redemption of the financial instrument/deposit voucher.

Upon customer's and retailer's authentication, the communication device (i.e., the retailer device in this case) may be used as a depositing unit for the customer in order to deposit the cash amount which is paid against the financial instrument/deposit voucher while purchasing it. Further the application program may be installed on the retailer device as well as on the customer device to enable the customer to instantly deposit the cash amount at the specified bank's account.

In an another aspect of the present subject matter, the customer may also use his/her mobile device/communication device (i.e., customer device) which may act similar to the retailer device as discussed above for depositing the cash amount into the specified bank's account. In this case, the application program may be installed in the customer device. Thus, the cash amount gets deposited instantly and the same can be reflected into the account without going into a multi-level process. Further, the financial instrument issued by the financial institution may not be associated with a particular customer only, i.e., the financial instrument issued is not personalized. Therefore, the financial instrument may be used by any customer to deposit the cash amount instantly in any bank issuing the said financial instrument.

While aspects of the described financial instrument, system and method for facilitating financial transaction may be implemented in any number of different computing systems, environments, and/or configurations, the embodiments are described in the context of the following exemplary system.

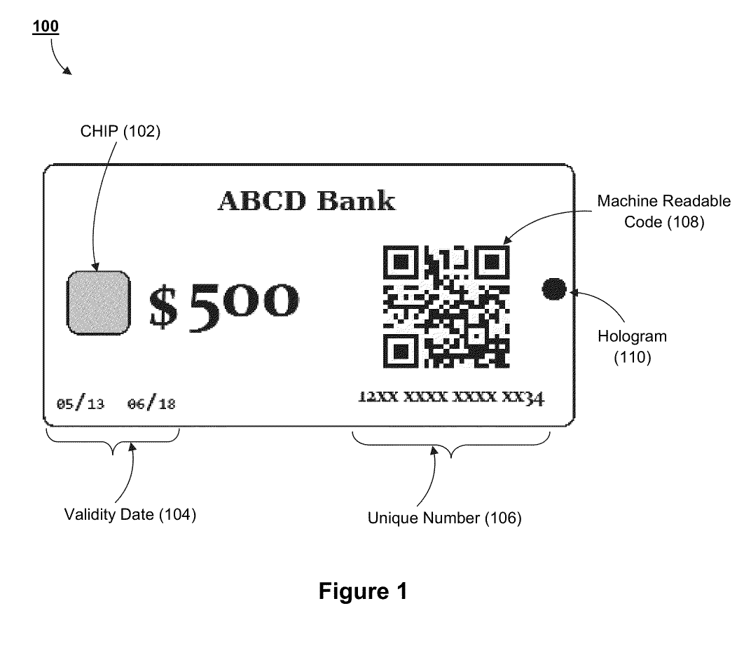

Referring to FIG. 1, the financial instrument/deposit voucher is illustrated, in accordance with an embodiment of the present subject matter. Hereinafter, the term “deposit voucher” and “financial instrument” will be collectively referred as “financial instrument”. The financial instrument 100 may comprise a chip 102, a validity date 104, a unique number 106, a machine readable code (i.e., QR Code) 108, and a hologram 110. According to an embodiment of the present disclosure, the validity date 104 and the unique number 106 may be imprinted on the financial instrument 100 which can be keyed in/scanned or can be swiped against a communication device belonging to a retailer or a customer during the activation of the financial instrument 100 by the bank's server. The financial instrument 100 which is generated and issued by the bank's server may be used by the retailer or the customer for depositing a cash amount instantly into a bank account specified by the customer.

Further, the financial instrument 100 may be generated in any physical form such as paper, plastic, etc. Also, the financial instrument 100 can be in rectangular shape, circular shape or any other shape. The chip 102 embedded into the financial instrument 100 may also comprise the validity date and unique number of the financial instrument 100, and any other confidential information required for depositing the cash amount. The hologram 110 engraved on the surface of the financial instrument 100 may comprise the bank's identification secure code for providing the identity of the specific bank or the financial institution which has issued the financial instrument 100 to the retailer. Further, the machine readable code (QR Code) 108 of the financial instrument 100 may comprise of all the aforementioned information including the unique number 106, the validity date 104 of the financial instrument 100, and the other confidential information required for depositing the cash amount in an encrypted form.

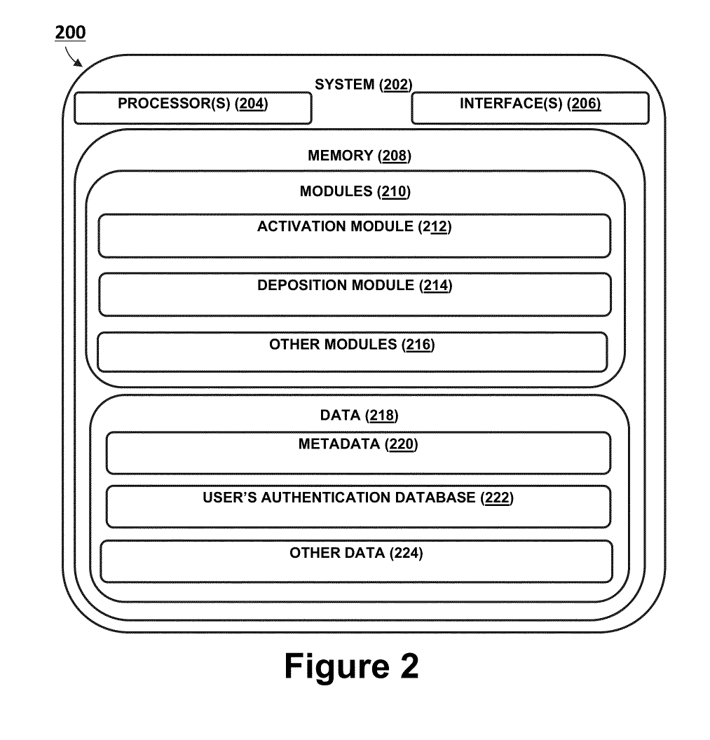

Referring to FIG. 2, a system 202 is illustrated in accordance with an embodiment of the present subject matter. The system 202 may include at least one processor 204, an input/output (I/O) interface 206, and a memory 208. The at least one processor may be implemented as one or more microprocessors, microcomputers, microcontrollers, digital signal processors, central processing units, state machines, logic circuitries, and/or any device that manipulates signals based on operational instructions. Among other capabilities, the at least one processor is configured to fetch and execute computer-readable instructions or modules 210 stored in the memory 208.

The I/O interface 206 may include a variety of software and hardware interfaces, for example, a web interface, a graphical user interface, and the like. The I/O interface 206 may allow the user (i.e., the retailer 306 or the customer 308) to interact with the system 202 (i.e., bank server) through the retailer device 312 or the customer device 314 respectively. Further, the I/O interface 206 may enable the system 202 to communicate with other computing devices, such as web servers and external data servers (not shown). The I/O interface 206 can facilitate multiple communications within a wide variety of networks and protocol types, including wired networks, for example, LAN, cable, etc., and wireless networks, such as WLAN, cellular, or satellite. The I/O interface 206 may include one or more ports for connecting a number of devices to one another or to another server.

The memory 208 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, compact disks (CDs), digital versatile disc or digital video disc (DVDs) and magnetic tapes. The memory 208 may also include a set of instructions or modules capable of performing processor-executable tasks. The memory 208 may include modules 210 and data 218.

The modules 210 include routines, programs, objects, components, data structures, etc., which perform particular tasks or implement particular abstract data types. In one implementation, the modules 210 may include an activation module 212, a deposition module 214, and other modules 216. The other modules 216 may include programs or coded instructions that supplement applications and functions of the system 202. The data 218, amongst other things, serves as a repository for storing data processed, received, and generated by one or more of the modules 210. The data 218 may also include a metadata 220, user's authentication database 222, and other data 224.

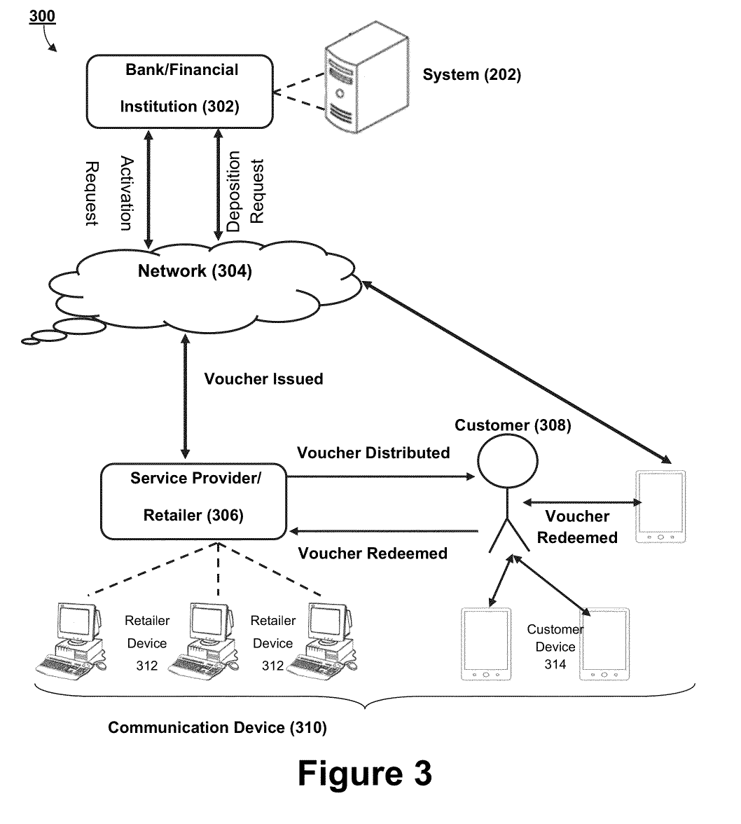

Referring to FIG. 3, a network implementation of the system 202 for depositing the cash amount using the financial instrument 100 is illustrated, in accordance with an embodiment of the present subject matter. In one embodiment, the system 202 facilitates the user (retailer 206 or customer 208) to deposit the cash amount instantly in an offline environment/mode into the bank account specified by the user. The financial instrument 100 may be generated by the bank or a financial institution 302. Hereinafter the term “bank” or “financial institution” will be collectively referred to as “financial institution” 302. The financial institution 302 facilitates the generation of the financial instrument 100. After generating the financial instrument 100, the financial institution 302 may use a printing device for printing the financial instrument 100 in a physical form. The financial instrument 100 may be in a form of plastic or paper form and may be in a shape of a rectangle, circular or any other shape. It should be noted to a person skilled in the art, that the financial instrument 100 may also be generated in an electronic form according to various embodiments of the present subject matter.

The financial instrument 100 after being generated and printed is issued to service providers/retailers 306 at different locations. In one embodiment, the financial instrument 100 may be issued to the customer 308. The financial instrument 100 issued to the retailer 306 has a certain monetary value associated with it, which may be 500, 1000, 1500, and 2000 and so on, but is not limited thereto. Also, the financial instrument 100 may be generated in different currencies like dollar, euro, rupee etc., according to the standards of different countries. After the financial instrument 100 is issued, the customer 308 may buy such financial instrument 100 from the retailer 306 located at different locations by paying the amount or the monetary value equivalent to the financial instrument 100.

Upon buying the financial instrument 100 from the retailer 306, the communicating device 310 (retailer device 312 or customer device 314) may be used to communicate with the system 202, whereby the system 202 activates the financial instrument 100 for the user (retailer or customer). For activating the financial instrument 100, an application program may be installed on the retailer device 312 or on the customer device 314. The application program may provide an interface for enabling the retailer 306 to enter required information for activating the financial instrument 100. In one embodiment, the application program may also enable the retailer device 312 or the customer device 314 to scan multiple financial instruments and aggregate the multiple financial instruments into a single activation request. At first, the activation module 212, of the system 202, receives an activation request, from the communication device 310, for activating the financial instrument 100 having a monetary value associated therewith. The activation request comprises metadata 220 associated with the activation request, whereby the metadata comprises a bank account of a user associated with the communication device 310. The metadata 220 further comprises a user's authentication code, bank details associated with the user (retailer or customer), user's personal details, and user's reference authentication data. Here, the user may be the retailer 306 or the customer 308. Further, the user's authentication code may be a retailer's authentication code or customer's authentication code.

In one scenario, the communication device 310 may be the retailer device 312 when the retailer 306 is communicating with the system 202. In another scenario, the communication device 310 may be the customer device 314 when the customer 308 is interacting with the system 202. After receiving the activation request, the activation module 212 may match the retailer's authentication code, the bank details associated with the customer 308, and customer's personal details of the metadata 220 for authenticating the financial instrument 100.

Once the financial instrument 100 gets authenticated for the user (retailer 306 or customer 308), the user may use such financial instrument 100 for depositing the cash amount equivalent to the financial instrument 100 into the bank account specified by the user, in real time. In one embodiment, the bank account specified by the user may be user's own account of the same bank/financial institution 302 which has issued the financial instrument 100 or a different bank/financial institution. Further, the bank account, specified by the user, may be any other bank account other than that which is owned by the user itself. It should be noted to the person skilled in the art that the user (i.e., the customer 308) may buy the financial instrument 100 from one retailer 306 at one location and can redeem the same financial instrument 100 at a secondary retailer located at a different location for facilitating the cash deposit equivalent to the amount quoted on the financial instrument 100. In this case, the secondary retailer will only initiate the deposition request for facilitating the cash deposition using the financial instrument 100 which was already activated by the prior retailer 306.

In order to deposit the financial instrument 100, the deposition module 214, of the system 202, receives a deposition request (after the activation of the financial instrument 100) from the communication device 310. The deposition request may comprise the full monetary value associated with the financial instrument 100 or a value less than the full monetary value. The deposition module 214 further processes the deposition request in order to deposit the monetary value into the bank account of the user associated with the communication device 310, wherein the bank account may be determined using the metadata 220.

Further, the deposition module 214 processes the deposition request in order to redeem the financial instrument 100. For depositing the financial instrument, the system 202 may provide several biometric authentication techniques such as Interactive Voice Recognition (IVR) calls, and other types of authentication techniques. In one embodiment, the deposition request may be processed by the deposition module 214 by initiating or triggering the biometric authentication, i.e., Interactive Voice Recognition (IVR) call to the user (the retailer 306 or the customer 308) for receiving authentication data associated with the user. Through the IVR call triggered, the user's identity and details of the transaction or deposition is verified. For verification, the deposition module 214 may match the authentication data with the user's reference authentication data. In another embodiment, the user's reference authentication data may be pre-verified IVR call details of the user and transaction details (i.e., a golden copy of the metadata) which have been previously stored in the user's authentication database 222 of the system 202. Thus, at the time of the verification, the deposition module 214 of the system 202 (i.e., bank's server) matches the pre-stored details (i.e., the user's reference authentication data) with the details input by the user (i.e., the authentication data) in real time for the authentication. Once the authentication data is successfully matched, the deposition module 214, of the system 202, deposits the monetary value/cash amount associated with the financial instrument 100 into the bank account specified by the user, and the same is reflected in the bank account in real time. It should be noted to the person skilled in the art, that another verification technique or biometric authentication technique other than the IVR calls may also be used for verification purposes.

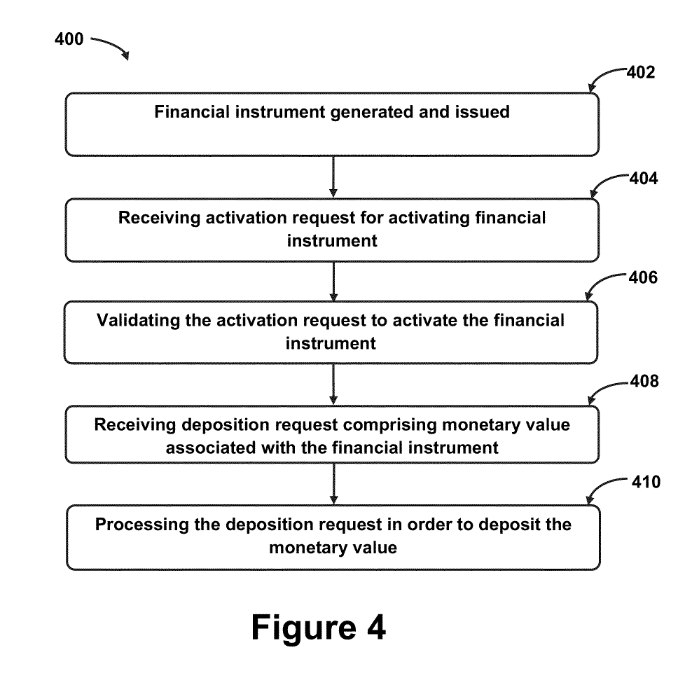

Referring now to FIG. 4, the method for facilitating a financial transaction (i.e., depositing the cash amount instantly into the bank account specified by the user) is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the disclosure described herein. Furthermore, the method can be implemented in any suitable hardware, software, firmware, or combination thereof. However, for ease of explanation, in the embodiments described below, the method 400 may be considered to be implemented in the above described system 202.

At block 402, a financial instrument 100 gets generated by financial institution 302 and issued to the user (retailer 306 or customer 308) at different locations. The financial instrument 100 may be generated in physical form, for example as a paper unit or a plastic unit. Further, the financial instrument 100 generated may be printed by a printing device (not shown in the figure) of the financial institution 302.

At block 404, an activation request may be received, from a communication device 310, for activating the financial instrument 100 having a monetary value associated therewith. The activation request comprises metadata 220 associated with the activation request, whereby the metadata 220 comprises the bank account of a user associated with the communication device 310.

At block 406, the activation request gets validated, thus activating the financial instrument 100. The activation request is validated based on the metadata 220.

At block 408, a deposition request may be received, wherein the deposition request comprises the monetary value associated with the financial instrument 100.

At block 410, the deposition request may be processed in order to deposit the monetary value into the bank account of the user.

Further, in another embodiment, the financial instrument 100 may be used for partially depositing the cash amount/monetary value associated with it. Specifically, the user may selectively redeem the financial instrument at different time intervals, wherein at each time interval a certain amount of the total cash amount value of the financial instrument may be deposited in the bank account specified by the user. This provides flexibility to the user to redeem the financial instrument (deposit voucher) as per the requirement of the user until the financial instrument (deposit voucher) expires by a date certain, which is the upper limit of the validity date 104 (Shown in FIG. 1).

Although implementations for methods and systems for depositing the cash amount instantly using the financial instrument 100 have been described in language specific to structural features and/or methods, it is to be understood that the appended claims are not necessarily limited to the specific features or methods described. Rather, the specific features and methods are disclosed as examples of implementations for depositing the cash amount by the user in real-time into the bank account specified by the user and reflecting the same immediately.

What is claimed is:

1. A system for facilitating a financial transaction using a financial instrument, the system comprising:
a processor;
a memory coupled to the processor, wherein the processor executes a plurality of modules stored in the memory, and wherein the plurality of modules comprises:
an activation module to
receive an activation request, from a communication device, for activating a financial instrument having a monetary value associated therewith, wherein the activation request comprises metadata associated with the activation request, and wherein the metadata comprises a bank account of a user associated with the communication device, and
validate the activation request for activating the financial instrument based upon the metadata; and
a deposition module to
receive, after the activation of the financial instrument, a deposition request, from the communication device, wherein the deposition request comprises the monetary value associated with the financial instrument; and
process the deposition request in order to deposit the monetary value into the bank account of the user associated with the communication device, the bank account being determined using the metadata.

2. The system of claim 1, wherein the financial instrument is in the form of at least one of a paper unit or a plastic unit, and wherein the financial instrument further comprises
a chip embedded onto the financial instrument, the chip further comprising a validity date, and an unique number associated with the financial instrument,
a hologram engraved on a surface of the financial instrument, the hologram further comprising a secure code for identification of a financial institution issuing the financial instrument, and
a machine readable code for storing the validity date, and the unique number associated with the financial instrument.

3. The system of claim 1, wherein the metadata further comprises a user's authentication code, bank details associated with the user, the user's personal details, and the user's reference authentication data.

4. The system of claim 3, wherein the deposition module processes the deposition request by:
initiating a biometric authentication to the user for receiving the authentication data associated with the user;
matching the authentication data with the user's reference authentication data; and
depositing the monetary value associated with the financial instrument into the bank account after the matching of the authentication data.

5. The system of claim 1, wherein the financial instrument is activated based on the user's authentication code.

6. The system of claim 1, wherein the communication device is at least one of a retailer device and a customer device.

7. A method for facilitating a financial transaction using a financial instrument, the method comprising:
receiving, by a processor, an activation request, from a communication device, for activating a financial instrument having a monetary value associated therewith, wherein the activation request comprises metadata associated with the activation request, and wherein the metadata comprises the bank account of a user associated with the communication device;
validating, by the processor, the activation request for activating the financial instrument based upon the metadata;
receiving, by the processor, after the activation of the financial instrument, a deposition request, from the communication device, wherein the deposition request comprises the monetary value associated with the financial instrument; and
processing, by the processor, the deposition request in order to deposit the monetary value into the bank account of the user associated with the communication device, the bank account being determined using the metadata.

8. The method of claim 7, wherein the metadata further comprises a user's authentication code, bank details associated with the user, the user's personal details, and the user's reference authentication data.

9. The method of claim 8, wherein the deposition request is processed by:
initiating a biometric authentication to the user for receiving authentication data associated with the user;
matching the authentication data with the user's reference authentication data; and
depositing the monetary value associated with the financial instrument into the bank account after the matching of the authentication data.

10. A non-transitory computer readable medium embodying a program executable in a computing device for facilitating a financial transaction using a financial instrument, the program comprising:
a program code for receiving an activation request, from a communication device, for activating a financial instrument having a monetary value associated therewith, wherein the activation request comprises metadata associated with the activation request, and wherein the metadata comprises the bank account of a user associated with the communication device;
a program code for validating the activation request for activating the financial instrument based upon the metadata;
a program code for receiving, after the activation of the financial instrument, a deposition request, from the communication device, wherein the deposition request comprises the monetary value associated with the financial instrument; and
a program code for processing the deposition request in order to deposit the monetary value into the bank account of the user associated with the communication device, the bank account being determined using the metadata.
